(19) United States
(12) Patent Application Publication
(10) Pub. No.: US 2023/0104058 A1
(43) Pub. Date: Apr. 6, 2023

(54) METHODS AND SYSTEMS FOR IMPROVING AN ESTIMATION OF A PROPERTY OF A QUANTUM STATE

(71) Applicant: 1QB INFORMATION TECHNOLOGIES INC., Vancouver (CA)

(72) Inventors: Florian HOPFMUELLER, Munich (DE); Elizabeth Roberts BENNEWITZ, Westport, CT (US); Bohdan KULCHYTSKYY, Waterloo (CA); Juan Felipe CARRASQUILLA ALVAREZ, Toronto (CA); Pooya RONAGH, Vancouver (CA)

(21) Appl. No.: 18/061,310

(22) Filed: Dec. 2, 2022

Related U.S. Application Data
(63) Continuation of application No. PCT/CA2021/050750, filed on Jun. 2, 2021.
(60) Provisional application No. 63/034,558, filed on Jun. 4, 2020.
(60) Provisional application No. 63/144,173, filed on Feb. 1, 2021.

(51) Int. Cl. G06N 10/70

(52) U.S. Cl. CPC G06N 10/70

(57) ABSTRACT

A method for improving an estimation of a property of a quantum state may include (a) using an interface of a digital computer to receive an indication of the property of the quantum state to be estimated; at least one quantum device; and at least one computational platform. The method may include using the at least one quantum device to obtain a plurality of measurement results of the quantum state. The method may include using the at least one computational platform to construct and train a neural network using the plurality of measurement results, wherein the neural network comprises at least one trainable parameter and wherein the neural network is representative of the quantum state. The method may include using the at least one computational platform and the property of the quantum state to train the at least one trainable parameter of the neural network to variationally improve the quantum state.

### CROSS-REFERENCE

This application is a continuation of International Application No. PCT/CA2021/050750, filed Jun. 2, 2021, which claims the benefit of U.S. Provisional Application No. 63/034,558, filed Jun. 4, 2020, and U.S. Provisional Application No. 63/144,173, filed Feb. 1, 2021, which are incorporated herein by reference in their entireties.

### BACKGROUND

New noisy intermediate-scale quantum (NISQ) devices are being developed, improved, and released. Despite being capable of performing various tasks such as optimization tasks and probabilistic sampling, these devices may lack accuracy. Moreover, connectivity between qubits may be limited by the physical routing of the wires on a qubit chip.

### SUMMARY

At least some of these drawbacks may be mitigated using hybrid quantum-classical optimization algorithms, such as variational quantum computing. However, hybrid algorithms may not be resilient against decoherence and gate errors, which may lead to inaccurate estimates of the expectation values. Furthermore, the variational quantum computing ansatz may generally not be universal, and consequently, variational quantum computing may result in an approximation to the target state. Yet, another disadvantage of this method is that the classical optimization of the variational quantum computing parameters is a complicated problem which may lead to suboptimal rather than optimal parameters.

Recognized herein is the need for methods and systems that will overcome the limitations associated with the accuracy of such devices and experiments.

The present disclosure provides methods and systems for improving an estimation of a property of a quantum state. In some cases, methods and systems disclosed herein may be used to mitigate errors in a neural-network representation of a quantum state for a quantum system. In some cases, methods and systems disclosed herein may improve an estimation of a property of a quantum state. In some cases, methods and systems disclosed herein can be applied with various quantum devices. In some cases, methods and systems disclosed herein can be applied to various quantum experiments and various quantum computations. In some cases, methods and systems disclosed herein can utilize various neural networks. In some cases, reconstructing the state using neural network tomography may allow for saving the state prepared by the quantum circuit. Creating a neural network wavefunction from the imperfect measurement may allow for extension the lifetime of the state outside of the experiment.

An advantage of the methods and systems disclosed herein is that they may be used to mitigate errors in a neural-network representation of a quantum state for a quantum system.

Another advantage of the methods and the systems disclosed herein is that they improve an estimation of a property of a quantum state.

Another advantage of the methods and the systems disclosed herein is that they can be applied with various quantum devices.

Another advantage of the methods and the systems disclosed herein is that they can be applied to various quantum experiments and various quantum computations.

Another advantage of the methods and the systems disclosed herein is that they can utilize various neural networks.

Another advantage of the methods and the systems disclosed herein is that reconstructing the state using neural network tomography allows us to save the state prepared by the quantum circuit. An advantage of creating a neural network wavefunction from the imperfect measurement allows for extension of the lifetime of the state outside of the experiment.

Another advantage of the methods and the systems disclosed herein is that, in some embodiments, for example, wherein a property is of a quantum state of a parametrized Hamiltonian, the property of the ground state may be estimated from a neural network quantum state at any value of the parameter, not just those being used in training.

Another advantage of the methods and the systems disclosed herein is that a neural network representative of a continuous family of quantum states may be constructed. A quantum state of a parametrized Hamiltonian may be represented using a limited number of parameter values which allows for extending the lifetime of an infinite number of related quantum states.

Aspects of the present disclosure provide a method for improving an estimation of a property of a quantum state. The method may comprise: (a) using an interface of a digital computer to receive an indication of (i) a property of a quantum state to be estimated; (ii) at least one quantum device; and (iii) at least one computational platform; (b)using said at least one quantum device to obtain a plurality of measurement results of said quantum state;(c)using said at least one computational platform to construct and train a neural network using said plurality of measurement results, wherein said neural network comprises at least one trainable parameter and wherein said neural network is representative of said quantum state; (d) using said at least one computational platform and said property of said quantum state to train said at least one trainable parameter of said neural network to variationally improve said quantum state of which said neural network is representative; and (e) providing an estimation of said property of said quantum state at said interface.

In some embodiments, the method further comprises repeating (a)-(d) until stopping criterion is met. In some embodiments, the (a) further comprises receiving an indication of a set of measurement operators; and wherein (b) further comprises, until a stopping criterion met: (i) using a quantum experiment to experimentally prepare an approximation of said quantum state; (ii) selecting a measurement operator from said set of measurement operators; and (iii) performing a measurement of said prepared quantum state using said selected operator from said set of measurement operators. In some embodiments, (i) further comprises applying at least one unitary transformation on an initial state.

In some embodiments, said neural network further comprises a cost function. In some embodiments, (c) comprises: (i) using said plurality of said measurement results to provide an input to said neural network; (ii) computing value of said neural network cost function; (iii) computing gradient of said cost function with respect to said at least one trainable parameter of said neural network; (iv) using said computed gradient and said computed cost function to update said at least one trainable parameter of said neural network; and (v) repeating (i)-(iv) a number of times. In some embodiments, regularization terms are added to said cost function.

In some embodiments, (d) comprises: (i) using said neural network to sample at least one configuration; (ii) using said at least one sampled configuration to estimate variational energy of said wavefunction represented by a mean of a local energy; (iii) using said at least one sampled configuration to estimate gradient of said variational energy with respect to said at least one parameter of said neural network; (iv) using said estimated variational energy and said estimated gradient of said variational energy to update said at least one parameter of said neural network; and (v) repeating (i)-(iv) until a stopping criterion is met. In some embodiments, regularization terms are added to said variational energy of said wavefunction.

In some embodiments, said quantum experiment comprises a quantum computation. In some embodiments, said quantum computation comprises at least one of circuit model quantum computation, quantum annealing. measurement-based quantum computation, and adiabatic quantum computing. In some embodiments, said at least one quantum device comprises at least one a quantum annealer, a trapped ion quantum computer, an optical quantum computer, a photonics-based quantum computer, a spin-based quantum dot computer and a superconductor-based quantum computer.

In some embodiments, said quantum state comprises a ground state of a Hamiltonian. In some embodiments, said quantum computation comprises solving an optimization problem; and further wherein said quantum state comprises a ground state of a Hamiltonian. In some embodiments, said Hamiltonian is representative of a classical optimization problem. In some embodiments, said ground state of said Hamiltonian is representative of an optimal solution of said optimization problem.

In some embodiments, (b) comprises performing variational quantum computing procedure. In some embodiments, said variational quantum computing procedure comprises: (i) obtaining an initial state; (ii) using a quantum processor comprising layers of parametrized quantum gates to prepare a multi-qubit quantum state by evolving said initial state through said layers of said parameterized quantum gates; (iii) computing variational energy of said prepared multi-qubit quantum state; (iv) using a classical optimization algorithm to update said parameters of said parametrized quantum gates to minimize said variational energy; (v) repeating (i)-(iv) a number of times; and (vi) providing said resulting quantum state.

In some embodiments, said quantum computation comprises quantum chemistry simulation; and wherein said quantum state is of a Hamiltonian representative of a quantum chemistry problem. In some embodiments, said Hamiltonian comprises electronic structure Hamiltonian of one of a molecule and material. In some embodiments, said property of said quantum state comprises an observable of said quantum state. In some embodiments, said observable of said quantum state is an expected energy of said quantum state.

In some embodiments, said neural network comprises at least one of an autoregressive model, a recurrent neural network, a transformer, an autoregressive generative model, an attention-based architecture, a dense deep neural network, a convolutional neural network, a variational autoencoder, a generative adversarial network, a restricted Boltzmann machines, a general Boltzmann machine, an energy-based model, invertible neural networks, and flow-based generative models. In some embodiments, (d) comprises using at least one of a tensor network ansatz, a Jastrow wave function, and a Hartree-Fock wave function.

In some embodiments, (c) comprises using at least one of a tensor processing unit (TPU), a graphical processing unit (GPU), a field-programmable gate array (FPGA), and an application-specific integrated circuit (ASIC). In some embodiments, said quantum state is of a parametrized Hamiltonian, further wherein a parametrization of said parameterized Hamiltonian is continuous. In some embodiments, said neural network further receives a parameter value of said parameterization as an input. In some embodiments, (e) comprises neural network inference for estimation of a property of a quantum state of said parametrized Hamiltonian with a parameter value not being used in training.

Another aspect of the present disclosure provides a system for improving an estimation of a property of a quantum state. The system may comprise: (a) a digital computer comprising an interface, a memory comprising instructions, wherein said digital computer is configured to execute said instructions to at least: receive an indication of (i) a property of a quantum state to be estimated; (ii) a set of measurement operators; (iii) at least one quantum device of a plurality of quantum devices; and (iv) at least one computational platform of a plurality of platforms; further wherein said digital computer is configured to provide an estimation of said property of said quantum state at said interface; (b) said at least one quantum device operatively connected to said digital computer, wherein said at least one quantum device comprises at least a quantum processor and a readout control system, wherein said at least one quantum device is configured to conduct a quantum experiment to obtain a plurality of measurement results of said quantum state using said readout control system; and (c) said at least one computational platform operatively connected to said digital computer, wherein said at least one computational platform comprises at least one processor and a readout control system, wherein said at least one computational platform is configured to (i) receive from said digital computer a configuration of a neural network comprising at least one trainable parameter, said plurality of measurement results, and said property of said quantum state (ii) to train said neural network, wherein said neural network is representative of said quantum state; and (iii) to train said at least one trainable parameter of said neural network to variationally improve said quantum state of which said neural network is representative.

In some embodiments, said computational platform comprises at least one member of the group consisting of field-programmable gate array (FPGA), an application-specific integrated circuit (ASIC), central processing unit (CPU), graphics processing unit (GPU), a tensor processing unit (TPU), a tensor streaming processor (TSP).

In another aspect, the present disclosure provides a method for reducing an error in an estimation of a property of a quantum state. The method may comprise: (a) receiving a set of measurements of a quantum state from a quantum device; (b) preparing a representation of said quantum state using a computational platform and said set of measurements, wherein said representation comprises a neural network comprising one or more tunable parameters; and (c) training said neural network by adjusting said one or more tunable parameters using said computational platform, wherein said training comprises a variational analysis, wherein said training reduces an error in said estimation of said property of said quantum state.

In some embodiments, said training comprises a variational Monte Carlo procedure. In some embodiments, said variational Monte Carlo procedure comprises a neural network representative of an ansatz ground state wavefunction. In some embodiments, said variational Monte Carlo procedure may comprise one or more of a tensor network ansatz, a Jastrow wave function, or a Hartree-Fock wave function.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a flowchart that shows an example of a method for improving an estimation of a property of a quantum state.

FIG. 2 is a flowchart that shows an example of a method for obtaining a plurality of measurement results of a quantum state.

FIG. 3 is a flowchart that shows an example of a method for constructing and training a neural network comprising at least one trainable parameter representative of a quantum state.

FIG. 4 is a flowchart that shows an example of a method for training the at least one trainable parameter of the neural network to variationally improve the quantum state the neural network is representative of.

FIG. 5 is a flowchart that shows an example of a method for performing variational quantum computing procedure.

FIG. 6 is a flowchart that shows an example of a method for preparing a multi-qubit quantum state and obtaining a plurality of measurements thereof.

FIG. 7 is a diagram of an example of a system for improving an estimation of a property of a quantum state.

FIG. 8 shows results for error mitigation using variational Monte Carlo on the Lattice Schwinger model with N=8 spins over the mass values m from [−1.8, 1.0].

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

The term “plurality” means “two or more,” unless expressly specified otherwise.

The term “herein” means “in the present application, including anything which may be incorporated by reference,” unless expressly specified otherwise.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

Where values are described as ranges, the disclosure includes the disclosure of all possible sub-ranges within such ranges, as well as specific numerical values that fall within such ranges irrespective of whether a specific numerical value or specific sub-range is expressly stated.

In the following detailed description, reference is made to the accompanying figures, which form a part hereof In the figures, similar symbols typically identify similar components, unless context dictates otherwise. The illustrative embodiments described in the detailed description, figures, and claims are not meant to be limiting. Other embodiments may be used, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

As used herein, the term “classical,” as used in the context of computing or computation, generally refers to computation performed using binary values using discrete bits without use of quantum mechanical superposition and quantum mechanical entanglement. A classical computer may be a digital computer, such as a computer employing discrete bits (e.g., 0's and 1's) without use of quantum mechanical superposition and quantum mechanical entanglement.

As used herein, the term “non-classical,” as used in the context of computing or computation, generally refers to any method or system for performing computational procedures outside of the paradigm of classical computing.

As used herein, the term “quantum device” generally refers to any device or system to perform computations using any quantum mechanical phenomenon such as quantum mechanical superposition and quantum mechanical entanglement.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device.

As used herein, the term “Noisy Intermediate-Scale Quantum device” (NISQ) generally refers to any quantum device which is able to perform tasks which surpass the capabilities of today's classical digital computers.

The present disclosure discloses of methods and systems for for improving an estimation of a property of a quantum state prepared using a quantum experiment using a quantum device.

Neither the Title nor the Abstract is to be taken as limiting in any way as the scope of the disclosed invention(s). The title of the present application and headings of sections provided in the present application are for convenience only and are not to be taken as limiting the disclosure in any way.

### NISQ—Noisy Intermediate-Scale Quantum Technology

The term Noisy Intermediate-Scale Quantum (NISQ) was introduced by John Preskill in “Quantum Computing in the NISQ era and beyond,” arXiv:1801.00862, which is incorporated herein by reference in its entirety. Here, “Noisy” implies that we have incomplete control over the qubits and the “Intermediate-Scale” refers to the number of qubits which can range from 50 to a few hundred. Several physical systems made from superconducting qubits, artificial atoms, ion traps are proposed so far as feasible candidates to build NISQ quantum device and ultimately universal quantum computers.

### Quantum Devices

Any type of quantum computers may be suitable for the technologies disclosed herein. In accordance with the description herein, suitable quantum computers may include, by way of non-limiting examples: superconducting quantum computers (qubits implemented as small superconducting circuits—Josephson junctions) (Clarke and Wilhelm, “Superconducting quantum bits,” Nature, 453.7198, 2008:1031); trapped ion quantum computers (qubits implemented as states of trapped ions) (Kielpinski et al., “Architecture for a large-scale ion-trap quantum computer,” Nature, 417.6890 (2002):709); optical lattice quantum computers (qubits implemented as states of neutral atoms trapped in an optical lattice) (Deutsch et al., “Quantum computing with neutral atoms in an optical lattice,” arXiv preprint quant-ph/0003022 (2000)); spin-based quantum dot computers (qubits implemented as the spin states of trapped electrons) (Imamoglu et al., “Quantum information processing using quantum dot spins and cavity QED,” arXiv preprint quant-ph/9904096 (1999)); spatial based quantum dot computers (qubits implemented as electron positions in a double quantum dot) (Fedichkin et al., “Novel coherent quantum bit using spatial quantization levels in semiconductor quantum dot,” arXiv preprint quant-ph/0006097 (2000)); coupled quantum wires (qubits implemented as pairs of quantum wires coupled by quantum point contact) (Bertoni et al., “Quantum logic gates based on coherent electron transport in quantum wires,” Physical Review Letters, Issue 84, no. 25 (2000):5912); nuclear magnetic resonance quantum computers (qubits implemented as nuclear spins and probed by radio waves) (Cory et al., “Nuclear magnetic resonance spectroscopy: An experimentally accessible paradigm for quantum computing,” arXiv preprint quant-ph/9709001(1997)); solid-state NMR Kane quantum computers (qubits implemented as the nuclear spin states of phosphorus donors in silicon) (Kane, Bruce E., “A silicon-based nuclear spin quantum computer,” Nature, Issue 393, no. 6681 (1998):133); electrons-on-helium quantum computers (qubits implemented as electron spins) (Lyon, Stephen A., “Spin-based quantum computing using electrons on liquid helium,” arXiv preprint cond-mat/0301581 (2006)); cavity quantum electrodynamics-based quantum computers (qubits implemented as states of trapped atoms coupled to high-finesse cavities) (Burell, Z., “An Introduction to Quantum Computing using Cavity QED concepts,” arXiv preprint arXiv:1210.6512 (2012)); molecular magnet-based quantum computers (qubits implemented as spin states) (Leuenberger and Loss, “Quantum computing in molecular magnets,” arXiv preprint cond-mat/0011415 (2001)); fullerene-based ESR quantum computers (qubits implemented as electronic spins of atoms or molecules encased in fullerenes) (Harneit, W., “Spin Quantum Computing with Endohedral Fullerenes,” arXiv preprint arXiv:1708.09298 (2017)); linear optical quantum computers (qubits implemented as processing states of different modes of light through linear optical elements such as mirrors, beam splitters and phase shifters) (Knill et al., “Efficient linear optics quantum computation,” arXiv preprint quant-ph/0006088 (2000)); diamond-based quantum computers (qubits implemented as electronic or nuclear spins of nitrogen-vacancy centres in diamond) (Nizovtsev et al., “A quantum computer based on NV centers in diamond: optically detected nutations of single electron and nuclear spins,” Optics and spectroscopy, Issue 99, no. 2 (2005):233-244); Bose-Einstein condensate-based quantum computers (qubits implemented as two-component BECs) (Byrnes et al., “Macroscopic quantum computation using Bose-Einstein condensates,” arXiv preprint quantum-ph/1103.5512 (2011)); transistor-based quantum computers (qubits implemented as semiconductors coupled to nanophotonic cavities) (Sun et al., “A single-photon switch and transistor enabled by a solid-state quantum memory,” arXiv preprint quant-ph/1805.01964 (2018)); rare-earth-metal-ion-doped inorganic crystal-based quantum computers (qubits implemented as atomic ground state hyperfine levels in rare-earth-ion-doped inorganic crystals) (Ohlsson et al., “Quantum computer hardware based on rare-earth-ion-doped inorganic crystals,” Optics communications, Issue 201, no. 1-3 (2002):71-77); metal-like carbon nanospheres based quantum computers (qubits implemented as electron spins in conducting carbon nanospheres) (Nafradi et al., “Room temperature manipulation of long lifetime spins in metallic-like carbon nanospheres,” arXiv preprint cond-mat/1611.07690 (2016)); and D-Wave' s quantum annealers (qubits implemented as superconducting logic elements) (Johnson et al., “Quantum annealing with manufactured spins,” Nature, Issue 473, no. 7346 (2011):194-198), each of which is incorporated herein by reference in its entirety.

### Quantum Annealer

A quantum annealer is an example of quantum mechanical system that may consist of a plurality of qubits.

Each qubit is inductively coupled to a source of bias called a local field bias. In some cases, a bias source is an electromagnetic device used to thread a magnetic flux through the qubit to provide control of the state of the qubit (e.g., U.S. patent application Ser. No. 2006/0225165, which is incorporated herein by reference in its entirety).

The local field biases on the qubits may be programmable and controllable. In some cases, a qubit control system comprising a digital processing unit is connected to the system of qubits and is capable of programming and tuning the local field biases on the qubits.

A quantum annealer may furthermore comprise a plurality of couplings between a plurality of pairs of the plurality of qubits. In some cases, a coupling between two qubits is a device in proximity to both qubits and threading a magnetic flux to both qubits. In some cases, a coupling may comprise a superconducting circuit interrupted by a compound Josephson junction. A magnetic flux may thread the compound Josephson junction and consequently thread a magnetic flux on both qubits (e.g., U.S. patent application Ser. No. 2006/0225165, which is incorporated herein by reference in its entirety). The strength of this magnetic flux may contribute quadratically to the energies of the quantum Ising model with the transverse field. In some cases, the coupling strength is enforced by tuning the coupling device in proximity of both qubits.

The coupling strengths may be controllable and programmable. In some cases, a quantum annealer control system comprising a digital processing unit may be connected to the plurality of couplings. In some cases, a quantum annealer control system comprising a digital processing unit may be capable of programming the coupling strengths of the quantum annealer.

In some cases, the quantum annealer performs a transformation of the quantum Ising model with the transverse field from an initial setup to a final one. In some cases, the initial and final setups of the quantum Ising model with the transverse field provide quantum systems described by their corresponding initial and final Hamiltonians.

In some cases, quantum annealers may be used as heuristic optimizers of their energy function. An example of such an analog processor is described in McGeoch and Wang, “Experimental Evaluation of an Adiabatic Quantum System for Combinatorial Optimization,” Computing Frontiers, May 14-16, 2013, and also disclosed in the Patent Application US 2006/0225165, each of which is incorporated herein by reference in its entirety.

In some cases, quantum annealers may be further used to provide samples from the Boltzmann distribution of a corresponding Ising model in a finite temperature. For example, Bian et al., “The Ising model: teaching an old problem new tricks,”2010, and also Amin et al., “Quantum Boltzmann Machine,” 2016, arXiv:1601.02036, which is incorporated herein by reference in its entirety. This method of sampling is called quantum sampling.

### Digital Computer

In some cases, the digital computer comprises one or more hardware central processing units (CPUs) that carry out the digital computer's functions. In some cases, the digital computer further comprises an operating system (OS) configured to perform executable instructions. In some cases, the digital computer is connected to a computer network. In some cases, the digital computer is connected to the Internet such that it accesses the World Wide Web. In some cases, the digital computer is connected to a cloud computing infrastructure. In some cases, the digital computer is connected to an intranet. In some cases, the digital computer is connected to a data storage device.

In accordance with the description herein, suitable digital computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use in some cases of the method and the system described herein. Select televisions, video players, and digital music players, in some cases with computer network connectivity, may be suitable for use with one or more variations, examples, or embodiments of the systems and the methods described herein. Suitable tablet computers may include those with booklet, slate, and convertible configurations.

In some cases, the digital computer comprises an operating system configured to perform executable instructions. The operating system may be, for example, software, comprising programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Microsoft® Xbox 360®, Microsoft Xbox One®, Nintendo® Wii®, Nintendo® Wii U®, and Ouya®.

In some cases, the digital computer comprises a storage and/or memory device. In in some cases, the storage and/or memory device is one or more physical apparatuses used to store data or programs on a temporary or permanent basis. In some cases, the device comprises a volatile memory and requires power to maintain stored information. In some cases, the device comprises non-volatile memory and retains stored information when the digital computer is not powered. In some cases, the non-volatile memory comprises a flash memory. In some cases, the non-volatile memory comprises a dynamic random-access memory (DRAM). In some cases, the non-volatile memory comprises a ferroelectric random access memory (FRAM). In some cases, the non-volatile memory comprises a phase-change random access memory (PRAM). In some cases, the device comprises a storage device including, by way of non-limiting examples, CD-ROMs, DVDs, flash memory devices, magnetic disk drives, magnetic tapes drives, optical disk drives, and cloud computing based storage. In some cases, the storage and/or memory device comprises a combination of devices, such as those disclosed herein.

In some cases, the digital computer comprises a display used for providing visual information to a user. In some cases, the display comprises a cathode ray tube (CRT). In some cases, the display comprises a liquid crystal display (LCD). In some cases, the display comprises a thin film transistor liquid crystal display (TFT-LCD). In some cases, the display comprises an organic light-emitting diode (OLED) display. In some cases, an OLED display comprises a passive-matrix OLED (PMOLED) or active-matrix OLED (AMOLED) display. In some cases, the display comprises a plasma display. In some cases, the display comprises a video projector. In some cases, the display comprises a combination of devices, such as those disclosed herein.

In some cases, the digital computer comprises an input device to receive information from a user. In some cases, the input device comprises a keyboard. In some cases, the input device comprises a pointing device including, by way of non-limiting examples, a mouse, trackball, trackpad, joystick, game controller, or stylus. In some cases, the input device comprises a touch screen or a multi-touch screen. In some cases, the input device comprises a microphone to capture voice or other sound input. In some cases, the input device comprises a video camera or other sensor to capture motion or visual input. In some cases, the input device comprises a Kinectφ, Leap Motion®, or the like. In some cases, the input device comprises a combination of devices, such as those disclosed herein.

### Neural Networks Representative of Quantum States

Recent development in machine learning have made neural networks relevant models for quantum systems. In some cases, neural networks may learn and represent probability distributions. As such, neural networks may be used as functional representations of the wavefunction describing a quantum state (e.g., J. Carrasquilla, “Machine learning for quantum matter,” 2020, which is incorporated herein by reference in its entirety). Neural network quantum state tomography may be one of the possible processes for training a neural network quantum state.

Quantum state tomography (QST) comprises the reconstruction of a quantum state using measurements. QST is a standard for verifying and benchmarking quantum devices (Cramer et al., “Efficient quantum state tomography,” Nature Communications, Issue 1, no. 1, (2010), which is incorporated herein by reference in its entirety). The number of measurements and time needed to reconstruct a state using QST may scale exponentially with system size. In neural network tomography, the wavefunction |(Ψ) [symbol] may be reconstructed from a set of measurements on the system. In some cases, this strategy maps the learned probability distribution of a neural network to the probabilistic representation of a wavefunction.

### Variational Monte Carlo

Variational Monte Carlo is a popular set of algorithms which iteratively improve a parametric classical representation of a quantum state or a set of quantum states, according to a given criterion, using a digital computer. There is a large variety of algorithms which may be referred to as VMC.

VMC algorithms may be iterative. In some cases, they may alternate between computing quantities related to the criterion and updating the parameters of the classical representation by a small amount until a stopping criterion is met.

The criterion may involve expected values of quantum operators under the represented quantum state. In some examples, the expected values may be estimated by expressing them as probabilistic expectations of the so-called local operators and using a Monte Carlo procedure.

A VMC algorithm may be applied to obtain an approximate classical representation of the ground state of a Hamiltonian. In some cases, the criterion is to minimize the expected value of the Hamiltonian, which may be expressed as a probabilistic expected value of the local energy. An estimate of the gradient of the expected value of the Hamiltonian with respect to the parameters of the representation may be computed. A gradient based optimization procedure may be used to update the parameters.

Error Mitigation using Variational Monte Carlo

As discussed herein, there are many potential sources of errors that may arise while preparing quantum states on a quantum computer and/or in representing these states. In some cases, ways to mitigate errors that arise from noisy and imperfect computations from NISQ devices can be advantageous.

Methods disclosed herein may be used to mitigate errors in a neural-network representation of a ground state for a quantum system. For example, improving neural-network quantum states reconstructed using neural-network quantum state tomography may be considered. In neural-network tomography, the information about the physical system may lie in the measurement data that is inputted into the neural-network. The cost function, which may be represented by the KL-divergence, may be used to train the network according to the measurement data. In some cases, training is performed without direct knowledge of the system. While this can be a powerful method for reconstructing a quantum state from data available in the lab, it may be limited in at least some instances by the number of available measurements. Further, in at least some instances, the method may be limited by the noise in the measurement data. In the NISQ era, it may be advantageous not to assume that the ground state was prepared perfectly or that the measurements were free of noise.

One potential route to improve the approximation of ground state prepared using a quantum device may comprise the post-processing of a neural network tomography state using variational Monte Carlo. As discussed above, variational Monte Carlo methods comprise training a neural-network quantum state by minimizing the variational energy of the quantum state. In some cases, post-processing using variational Monte Carlo may be considered as fine-tuning the neural network parameters to improve the estimation of the ground state.

One of potential bottleneck of variational Monte Carlo may be the expressibility of the chosen wavefunction ansatz. Another potential bottleneck may depend on how broadly the Hilbert space can be sampled. At least in part to either of these potential limitations and without being limited by theory, variational Monte Carlo may be sensitive to the initial ansatz and, in some cases, may get stuck in local minima or saddle points at least in part due to this sensitivity. In some cases, a trained neural network wavefunction may be used as the initial ansatz for variational Monte Carlo. In some cases, the method may assume that the wavefunction, |Ψ_{λ} [symbol] , already exists in the relevant Hilbert space, H. In some cases, the methods and systems disclosed herein comprise: preparing a representation of the ground state using a quantum device and captured using neural network tomography and improving the quantum state by training the neural network via minimizing the energy of the quantum state and its observables. Using the methods and systems disclosed herein, direct information about the Hamiltonian and the energy of the state of interest may be used to get a better representation of the system's ground state. Using the methods and systems disclosed herein, errors in the neural network representation may be mitigated by fine tuning the parameterization using variational Monte Carlo.

### Computational Platform

Computational platform as disclosed herein may comprise various types of hardware. Each of type hardware may be used as part of the system, to execute the whole method, or any part of it, alone, or in combination with other hardware. In some cases, the hardware may be used for various operations of the methods disclosed herein, including, for example, one or more of the following: Experimentally preparing an approximation of a quantum state.

Performing one or more measurements of the prepared quantum state.

Computing a value of the neural network cost function.

Computing a gradient of the cost function.

Estimating a variational energy of the wavefunction.

Generation of random numbers.

Updating one or more neural network parameters.

Updating one or more parameters of parametrized quantum gates.

Performing a quantum evolution.

Execution of one or more functions of the interface, including a part or all of the above.

A computational platform may comprise a central processing unit (CPU). A CPU may be a low latency integrated circuit chip which comprises the main processor in a computer. A CPU may execute instructions as given by an algorithm. A CPU may comprise a component configured to do one or more of the following: executing arithmetic and logic operations, registering that store the results of those operations, and directing the operations of the former using a control unit.

A computational platform may comprise a graphics processing unit (GPU). A GPU may be specialized electronic circuit optimized for high throughput - can perform the same set of operations in parallel on many data blocks at a time.

A computational platform may comprise a field-programmable gate array (FPGA). An FPGA may comprise an integrated circuit chip that comprises configurable logic blocks and programmable interconnects. Can be programmed after manufacturing to execute custom algorithms.

A computational platform may comprise an application-specific integrated circuit (ASIC). An ASIC may be an integrated circuit chip that is customized to run a specific algorithm. In some instances, an ASIC is not programmed after manufacturing.

A computational platform may comprise a tensor processing unit (TPU). A TPU may comprise a proprietary type of ASIC developed for low bit precision processing by Google® Inc., see Patent Application US 2016/0342891, which is incorporated entirely herein by reference for all purposes.

A computational platform may comprise a tensor streaming processor (TSP). A TSP may be a domain-specific programmable integrated chip that is designed for linear algebra computations as they may be performed in Artificial Intelligence applications (e.g., Gwennap, “Grog Rocks Neural Networks,” The Linley Group Microprocessor Report, January 6, 2020, which is incorporated entirely herein by reference for all purposes).

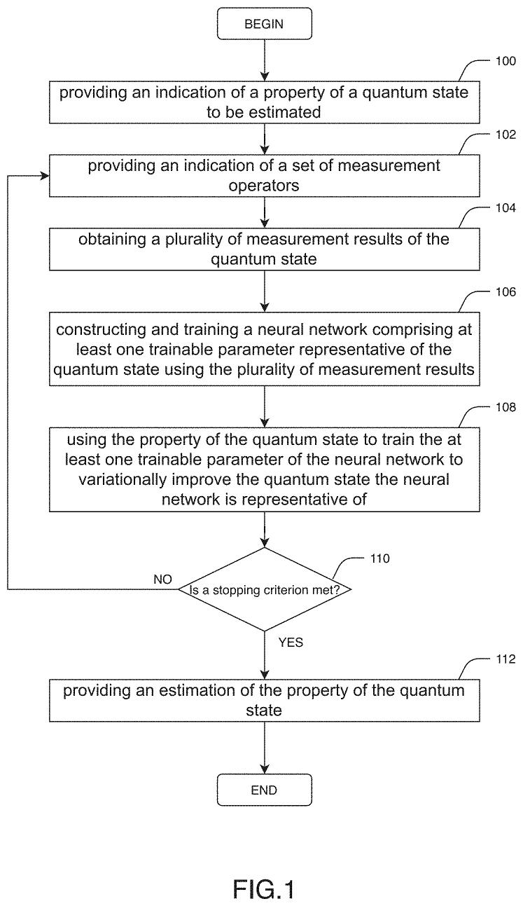

Now referring to FIG. 1, there is shown a flowchart of an example of a method for improving an estimation of a property of a quantum state. In some cases, the method may reduce an error in an estimation of a property of a quantum state.

According to processing operation 100, an indication of a property of a quantum state to be estimated is provided. In some cases, the property of a quantum state may be of various types. The property of the quantum state may comprise an observable of the quantum state. In some cases, the observable of the quantum state is the expected energy of the quantum state. In some cases, an indication of a property of a quantum state comprises a Hamiltonian. In some cases, the quantum state may be a ground state of a Hamiltonian. The quantum state may be an excited state of a Hamiltonian. In some cases, the Hamiltonian is a representative of a classical optimization problem and the ground state is a representative of the optimal solution of the classical optimization problem.

In some cases, the Hamiltonian is a parametrized Hamiltonian representative of a family of Hamiltonians. In some cases, the parametrization is continuous. The property of the ground state of the Hamiltonian may be estimated for each possible value of the parameter. In some cases, the parameter may comprise a multi-dimensional parameter. In some cases, each parameter value defines a Hamiltonian.

According to processing operation 102, an indication of a set of measurement operators is provided. In some cases, the measurement operator may be of various types. In some cases, the measurement operator is any of the Pauli operators. In some cases, the set of measurement operators may comprise a set of tensor products of Pauli operators acting on the qubits of the quantum device. In some cases wherein the quantum state whose property is to be estimated is the ground state of a Hamiltonian, the set of tensor products of Pauli operators is chosen so that the Hamiltonian may be expressed as a weighted sum of them. In some cases, the set of tensor products of Pauli operators is chosen so that the non-computational basis measurements acting on the qubits in a quantum device are reduced. For example, a set of tensor product Pauli operators may put low weight on X, Y measurements such as tensor product Pauli operators with only one or two X, Y operators and with Z operators everywhere else such as ZZZZZX, ZZZZXX, ZZZZZY, ZZZZYY.

In some cases, the set of measurement operators is chosen so that the measurement results (optionally together with any knowledge about properties of the prepared state) allow reconstruction the prepared state to an approximation using tomography.

According to processing operation 104, a plurality of measurement results of the quantum state is obtained. In some cases, the plurality of measurement results is obtained using a quantum experiment using a quantum device. In some cases, the quantum state is of the parametrized Hamiltonian, and a plurality of possible values of the parameter is selected and a plurality of measurement results of the quantum state is obtained for each parameter value of the selected plurality of possible values.

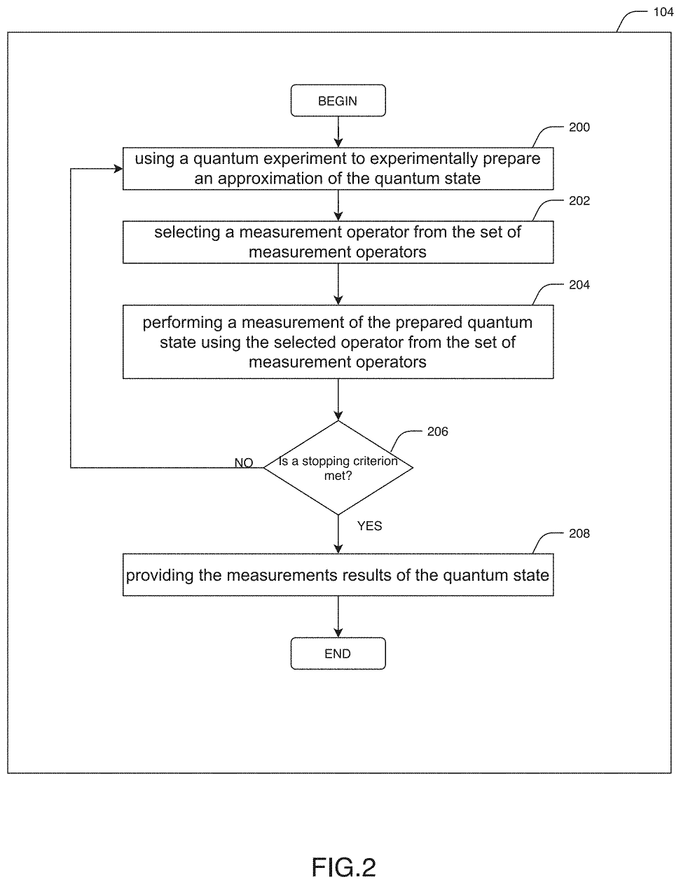

Now referring to FIG. 2, there is shown a flowchart of an example of a method for obtaining a plurality of measurement results of a quantum state.

According to processing operation 200, the quantum state is prepared experimentally using the quantum device to perform a quantum experiment. In some cases, the quantum experiment may be of various types such as any quantum experiment disclosed herein. In some cases, performing a quantum experiment to prepare a quantum state experimentally comprises applying at least one unitary transformation on an initial state of qubits. In some cases, the quantum experiment comprises a quantum computation. In some cases, the quantum computation may comprise at least one member of the group consisting of circuit model quantum computation, quantum annealing, measurement-based quantum computation, and adiabatic quantum computing. In some cases, a quantum computation may comprise variational quantum computing procedure described below.

In some cases, the quantum computation comprises solving an optimization problem. In some cases, the quantum computation comprises a quantum chemistry simulation. The Hamiltonian may comprise an electronic structure Hamiltonian of one of a molecule and material, and the quantum state may be an eigenstate of the Hamiltonian.

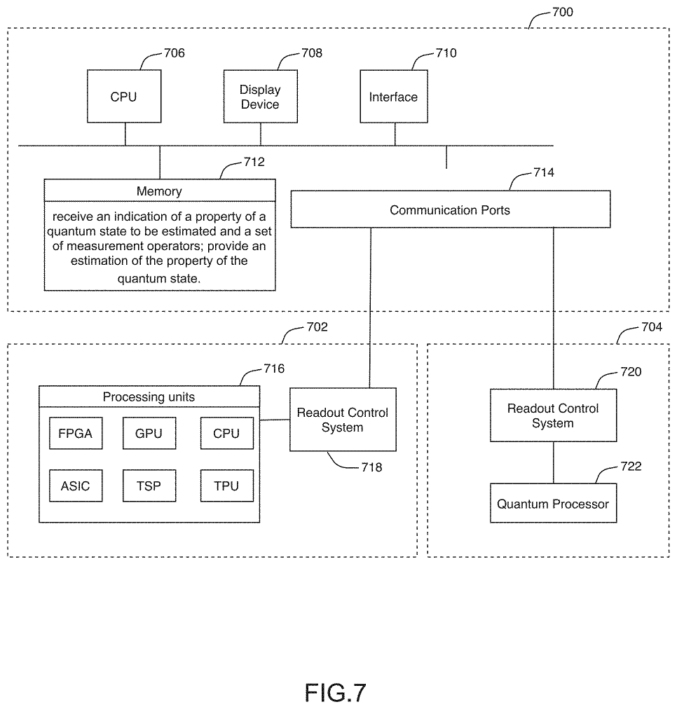

In some cases, the quantum device may be of various types, such as any quantum device disclosed herein. The quantum device may be any suitable quantum device such as any quantum device 704 described herein with respect to the system shown in FIG. 7. The quantum device may be of any type suitable for the methods disclosed herein. In some cases, the quantum device comprises a NISQ device. In some cases, the quantum device comprises superconducting qubits. The quantum device may comprise at least one member of the group consisting of a quantum annealer, a trapped ion quantum computer, an optical quantum computer, a photonics-based quantum computer, a spin-based quantum dot computer.

Still referring to FIG. 2 and according to processing operation 202, a measurement operator may be selected from the set of measurement operators. In some cases, the selection criterion is based on the order of the measurement operators in the list. In some cases, the selection criterion is based on the measurement operators that have been selected so far. In some cases, the selection criterion is based on the measurement operators selected so far and the measurement results obtained so far.

According to processing operation 204, a measurement of the prepared quantum state is performed using the selected operator. In some cases, the measurement procedure varies according to the nature of the quantum device. It may involve applying further unitary transformations to the prepared quantum state, an experimental readout procedure and post-processing using electronics and/or a digital computer. The experimental readout procedure may be performed using a readout control system, such as a readout control system described herein with respect to the system shown in FIG. 7.

According to processing operation 206, a stopping criterion may be verified. If the stopping criterion is met, the measurement results of a quantum state may be provided according to processing operation 208, and if the stopping criterion is not met, the processing operations 200, 202, and 204 may be repeated. In some cases, the stopping criterion may be of various types. In some cases, the stopping criterion is that processing operations 200, 202, and 204 are repeated a given number of times. In some cases, the stopping criterion is that a given function of the set of operators selected so far and the measurement results obtained so far exceeds a given value.

Now referring back to FIG. 1 and according to processing operation 106, a neural network comprising at least one trainable parameter may be constructed and trained using at least one computational platform. In some cases, the neural network is representative of the quantum state. In some cases, the quantum state tomography may be used to perform the neural network training. In some cases, the neural network is trained using the plurality of the measurement results. In some cases, the neural network may be of various types. The neural network types include but not limited to autoregressive model, a recurrent neural network, a transformer, an autoregressive generative model, an attention-based architecture, a dense deep neural network, a convolutional neural network, a variational autoencoder, a generative adversarial network, a restricted Boltzmann machines, a general Boltzmann machine, an energy-based model, invertible neural networks, and flow-based generative models.

In some cases, the computational platform may be of various types. The computational platform may be any suitable computational platform such as any computational platform described herein with respect to the system shown in FIG. 7. In some cases, the computational platform comprises at least one member of the group consisting of a field programmable gate array (FPGA), an application-specific integrated circuit (ASIC), central processing unit (CPU), graphics processing unit (GPU), a tensor processing unit (TPU), and a tensor streaming processor (TSP).

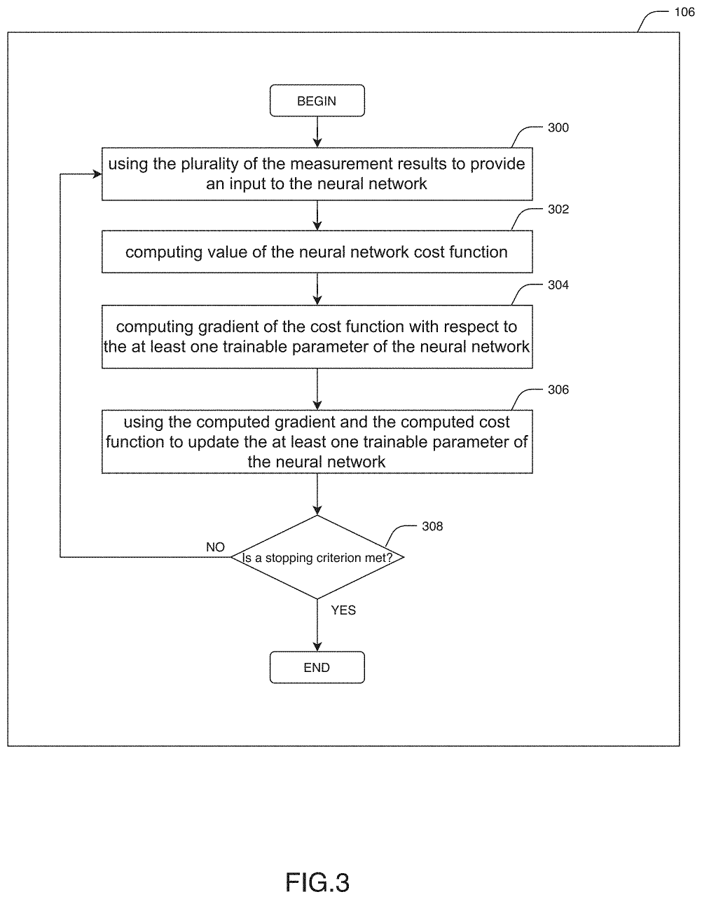

Now referring to FIG. 3 there is shown a flowchart of an example of a method for constructing and training a neural network comprising at least one trainable parameter representative of the quantum state. In some cases, constructing and training the neural network may comprise using at least one member of the group consisting of a tensor processing unit (TPU), a graphical processing unit (GPU), a field-programmable gate array (FPGA), a tensor streaming processor (TSP), and an application-specific integrated circuit (ASIC).

According to processing operation 300, an input to the neural network is provided using the plurality of the measurement results. In some cases, the quantum state is of the parametrized Hamiltonian, and the input to the neural network further comprises the selected parameter values corresponding to the measurement results. In some cases, input data comprises the plurality of the measurement results with the corresponding parameter values. In some cases, the plurality of the measurement results may be preprocessed before training. In some cases, the quantum state is of the parametrized Hamiltonian, and the plurality of measurements results is preprocessed together with the corresponding parameter values. In some cases, the input data is separated into training and validation data. In some cases, the training data is divided into batches. In some cases, the training procedure may depend on the specific type of the neural network. For example, and in some cases, the neural network is an energy-based model and the training procedure is a contrastive divergence type procedure. In some cases, the neural network is an autoregressive model and the training procedure consists of maximizing the likelihood of the training inputs.

According to processing operation 302, the cost function value is computed for the neural network. In some cases, the neural network cost function may be of various types. The neural network cost function types may include but are not limited to the cross entropy between the empirical distribution of measurement results and the probabilities assigned to those results by applying the Born rule on the quantum state represented by the neural network. For example, the cost function L is given by

$$L = - \frac{1}{M} {Σ}_{i = 1}^{M}$$

In p(rᵢ), where rᵢ is a measurement result and p(rᵢ) is the probability assigned to rᵢ by the neural network. In some cases, a measurement result is characterized by a Pauli string bᵢ describing the Pauli basis that was measured in, and a bit-string sᵢ describing the measurement result for each qubit. In some cases, p(rᵢ)=|Σ_{s′}|(U^{b}^{ᵢ})_{s′s}_{ᵢ}ψ(s′)|² where U^{b}^{ᵢ} is the unitary operator describing the basis change from the basis bᵢ into the computational basis, and ψ(s′) is the complex amplitude assigned to the computational basis state s′ by the neural network wavefunction ψ.

In some cases, the neural network cost function type may depend on the specific type of the neural network. For example, in some cases, the neural network represents unnormalized quantum states, and the cost function may account for the normalization.

In some cases, regulation terms may be added to the cost function. The regulation terms may be of various types, the regulation terms may include but not limited to an L1 term, an L2 term and an entropy term. A schedule may be used to control the contribution of the regularization terms in the course of training.

Still referring to FIG. 3 and according to processing operation 304, gradient of the cost function with respect to the at least one trainable parameter of the neural network is computed. In some cases, the computation may depend on the specific type of the neural network.

According to processing operation 306, the at least one trainable parameter is updated using the computed cost function value and the gradient. In some cases, the type of the at least one trainable parameter may depend on the specific type of the neural network. In some cases, the neural network is an LSTM recurrent neural network, and the trainable parameters comprise the weights and biases of one or several layers of cells and gates. In some cases, the neural network is a restricted Boltzmann machine, and the trainable parameters are the weights associated with the connection between each hidden unit and each visible unit.

According to processing operation 308, if the stopping criterion is met the training procedure is terminated; if the stopping criterion is not met processing operations 300, 302, 304, and 306 repeated. In some cases, the stopping criterion is that processing operations 300, 302, 304, and 306 are repeated a given number of times. In some cases, the stopping criterion is that the at least one trainable parameter value converges.

Now referring back to FIG. 1 and according to processing operation 108, the at least one trainable parameter of the neural network may be trained using the property of the quantum state to variationally improve the quantum state the neural network is representative of. In some cases, the training may be performed using at least one computational platform. The training may be performed using a variational Monte Carlo procedure. In some cases, the variational Monte Carlo procedure comprises a neural network representative of an ansatz ground state wavefunction. In some cases, the at least one learning parameter of the neural network is representative of a set of variational degrees of freedom. The variational Monte Carlo procedure may be performed to improve the estimation of the property of the quantum state, such as for example reducing an error in the estimation. In some cases, performing a variational Monte Carlo procedure may comprise one or more of a tensor network ansatz, a Jastrow wave function, or a Hartree-Fock wave function.

In some cases, the computational platform may be of various types. The computational platform may be any suitable computational platform such as any computational platform described herein with respect to the system shown in FIG. 7. In some cases, the computational platform comprises at least one member of the group consisting of a field programmable gate array (FPGA), an application-specific integrated circuit (ASIC), central processing unit (CPU), graphics processing unit (GPU), a tensor processing unit (TPU), and a tensor streaming processor (TSP).

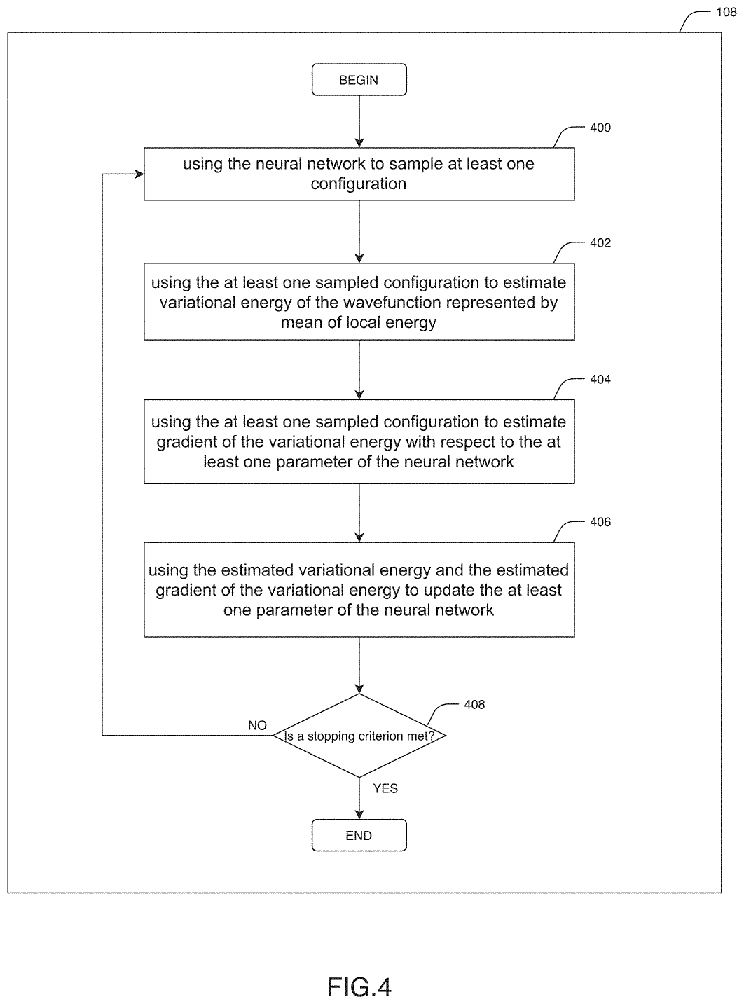

Now referring to FIG. 4 there is shown a flowchart of an example of a method for training the at least one trainable parameter of the neural network to variationally improve the quantum state of the neural network.

According to processing operation 400, the trained neural network is used to sample at least one configuration. In some cases, the quantum state is of the parametrized Hamiltonian, and a plurality of possible parameter values is sampled, then the sampled plurality of the possible parameter values is provided to the neural network as an input, and at least one configuration is sampled from the neural network for each parameter value. For example, in some cases, the neural network is an autoregressive model, and the at least one configuration is sampled via sampling from the conditional probabilities which are represented by the autoregressive model.

According to processing operation 402, variational energy of the wavefunction represented by mean of local energy is estimated using the at least one sampled configuration. In some cases, the variational energy of the wavefunction is estimated via the formula

$${E}_{var} = \frac{1}{M} {Σ}_{i = 1}^{M} {E}_{loc} ( {s}_{i} , ψ ) ,$$

where Eᵥₐᵣ is the variational energy, sᵢ are the sampled configurations, and E_{loc}(sᵢψ) is the local energy. The local energy in turn is given by

$${E}_{loc} ( {s}_{i} , ψ ) = \frac{{Σ}_{{s}^{′}} {H}_{{s}_{i} {s}^{′}} ψ ( {s}^{′} )}{ψ ( {s}_{i} )} ,$$

where Hₛ_{ⁱ}_{s′} is a matrix element of the operator whose expectation value is being estimated, and ψ(s) is the complex amplitude assigned by the neural network wavefunction to the configuration s.

In some cases, the quantum state is of the parametrized Hamiltonian, and the variational energy for each sampled parameter value are combined into one loss function. In some cases, the loss function may comprise the mean over sampled parameter values of the variational energy, or the sum of variational energies weighted by a function of the parameters.

In some cases, regulation terms may be added to the variational energy. The regulation terms may be of various types. The regulation terms may include but not limited to an L1 term, an L2 term and an entropy term. A schedule may be used to control the contribution of the regularization terms in the course of training.

In some cases, the underlying probability distribution of quantum chemistry systems may sharply peaked resulting in ground states that may be sparse. In some cases, wherein the Hamiltonian is electronic structure Hamiltonian the regularization terms may be added to the variational energy to overcome the sparsity in the ground states. Ground states in Electronic Structure Theory may be peaked at the Hartree-Fock state. There may exist one computational basis state that is more common and a few less-likely non-dominant states that characterize the ground state.

In some cases, the sampled configuration is more likely to be the dominant Hartree-Fock state. It may result in training the neural network to represent the dominant Hartree-Fock state, because of the oversampling this state in the course of training. As a consequence, since the neural network is representing the Hartree-Fock state and has near-zero amplitudes for any other state, it may not learn the phase structure. In some cases, the phase structure may important for learning the ground state and navigating through the optimization space. In order to avoid the wave function collapsing to the Hartree-Fock state (a sparse solution) and not learning the phase structure, regularization terms may be added to the loss function represented by the variational energy. In some cases, regularization terms that discourage sparse solutions, such as L1 and entropy, may be added to the loss function. In the early iterations of the training, the regularization terms may stimulate the neural network to over-represent the amplitudes of all computational basis states, enabling the neural network to learn the phase structure. In some cases, a schedule may be used to reduce the contribution of regularization terms. Since regularization terms may enable the network to learn the phase structure, the optimization may be able to more effectively navigate the optimization space and accurately represent the amplitudes of the Hartree-Fock state and the non-dominant states.

Still referring to FIG. 4 and according to processing operation 404, a gradient of the variational energy with respect to the at least one parameter of the neural network is estimated using the at least one sampled configuration. In some cases, the gradient of the variational energy is estimated via the formula

$${∇}_{θ} {E}_{var} \approx \frac{2}{M} \cdot Re ( {\sum }_{i = 1}^{M} ( {E}_{l o c}^{*} ( {s}_{i} , ψ ) - {E}_{var} ) {∇}_{θ} ln ψ ( s ) ) ,$$

where θ are the parameters of the neural network and the rest of the notations is as above. In some cases, the quantum state is of the parametrized Hamiltonian, and the gradient is estimated using the at least one sampled configuration and the corresponding parameter value.

Still referring to FIG. 4 and according to processing operation 406, the at least one parameter of the neural network may be updated using the estimated variational energy and the estimated gradient of the variational energy. In some cases, the at least one parameter is updated according to θ←- ϵ∇_{θ}Eᵥₐᵣ, where ∇_{θ}Eᵥₐᵣ is estimated as in the above and ϵ is the learning rate. In some cases, the Adam optimizer is used to update the at least one parameter, taking as input the same estimate of ∇_{θ}Eᵥₐᵣ.

Still referring to FIG. 4 and according to processing operation 408, if the stopping criterion is met, the procedure is terminated; if not processing operations 400, 402, 404, and 406 are repeated. In some cases, the stopping criterion is that the variational energy is reduced to within a threshold, such as a threshold value, a number of iterations, an amount of reduction in the value, etc.

Now referring back to FIG. 1 and according to processing operation 110, the stopping criterion is verified; if the stopping criterion is met the property of the quantum state is estimated and provided according to processing operation 112; if the stopping criterion is not met processing operations 102, 104, 106, and 108 are repeated. In some cases, the stopping criterion may be of various types. In some cases, the stopping criterion is that processing operations 102, 104, 106, and 108 are repeated a given number of times. In some cases, the stopping criterion is that the property estimation is of sufficient quality.

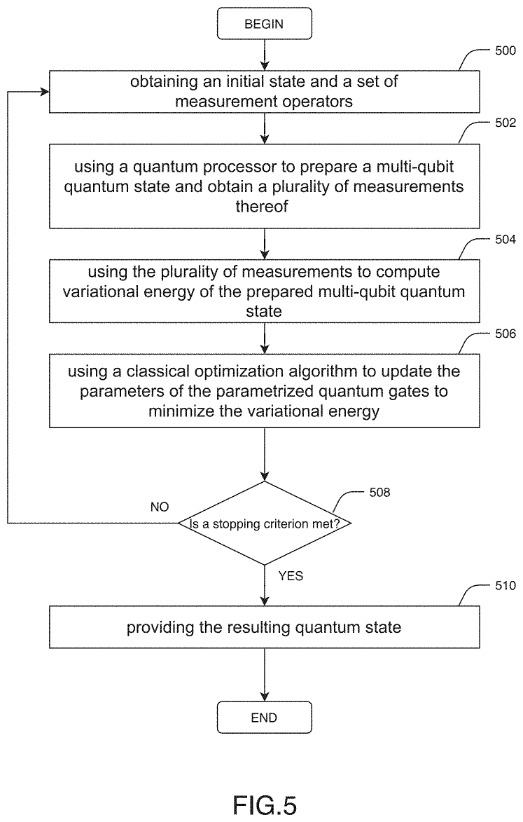

Now referring to FIG. 5, there is shown an example of a method for performing a variational quantum computing procedure. The variational quantum computing procedure comprises applying a hybrid quantum-classical optimization algorithm using a quantum device comprising a quantum processor comprising layers of parametrized quantum gates. The quantum device may be any quantum device comprising quantum gates, which can be parametrized. The quantum device may be any quantum device which is suitable for the technology, such as any quantum device disclosed herein, for example, as described with respect to the system shown in FIG. 7. In some cases, the quantum device is a trapped-ion analog quantum simulator, such as trapped-ion analog quantum simulators by IonQ™ or Innsbruck University. In some cases, the quantum device is a superconducting circuit model quantum device such as quantum devices manufactured by IBM®, Rigetti® or Google®. The quantum device may be at least one member of the group consisting of CV quantum computing by Xanadu™, cold atom quantum simulator such as quantum simulators manufactured by ColdQuanta™ and Atom Computing™, and an annealer such as annealers manufactured by NTT™, D-Wave™ and QEO™.

According to processing operation 500, an initial state and a set of measurements operators are obtained. In some cases, the initial state is taken to be the standard initial state |0 0 0 . . . 0> for each iteration. In some cases, the initial state is the equal superposition of all computational basis states|+>ⁿ. In some cases, the measurement operators may be of various types. In some cases, the measurement operators are Pauli operators.

According to processing operation 502, a multi-qubit quantum state is prepared.

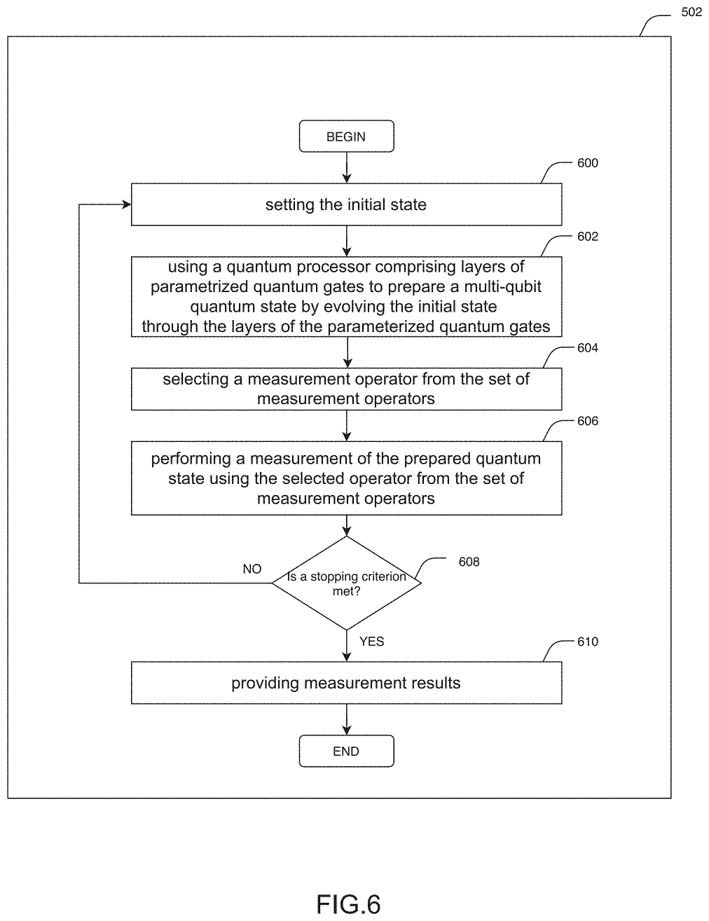

Now referring to FIG. 6, there is shown an example of a method for preparing a multi-qubit quantum state and obtaining a plurality of measurements thereof.

According to processing operation 600 the initial state is set on the quantum device.

According to processing operation 602 a multi-qubit quantum state is prepared. The preparation may comprise using the quantum device comprising a quantum processor comprising layers of the parametrized quantum gates to evolve the initial state through the layers of the parametrized quantum gates. In some cases, the quantum device is a trapped-ion analog quantum simulator, and the layers are a sequence alternating between single-qubit rotations and time evolution with a Hamiltonian with long-range couplings, and the parameters are the rotation angles and evolution times.

Still referring to FIG. 6 and according to processing operation 604 a measurement operator is selected from the set of the measurement operators. In some cases, the selection criterion is based on the order of the measurement operators in the list. In some cases, the selection criterion is based on the measurement operators that have been selected so far. In some cases, the selection criterion is based on the measurement operators selected so far and the measurement results obtained so far.

According to processing operation 606 a measurement of the prepared quantum state is performed using the selected operator. In some cases, the measurement procedure varies according to the nature of the quantum device. It may involve applying further unitary transformations to the prepared quantum state, an experimental readout procedure and post-processing using electronics and/or a digital computer.

According to processing operation 608 a stopping criterion is verified. For example, if the stopping criterion is met measurement results of a quantum state are provided according to processing operation 610; if the stopping criterion is not met the processing operations 600, 602, 604 and 606 are repeated. In some cases, the stopping criterion may be of various types. In some cases, the stopping criterion is that processing 600, 602, 604 and 606 are repeated a given number of times. In some cases, the stopping criterion is that a given function of the set of operators selected so far and the measurement results obtained so far exceeds a given value.

Now referring back to FIG. 5 and according to processing operation 504, variational energy of the prepared multi-qubit quantum state is computed using the provided measurements results. In some cases the Hamiltonian of a system is described by Ĥ=ΣE_{α}h_{α}P_{α}, where h_{α} is a scalar coefficient and P_{α} is a Pauli string of single qubit Pauli operators σ_{α}ⁱ ∈{σₓⁱ, σ_{y}ⁱ, σ_{z}ⁱ, Π}. The variational energy of the state prepared in processing operation 502, |Ψ(θ)), may be defined as E(θ)= [symbol] Ψ(74 )|Ĥ|Ψ(θ) [symbol] , where θ are the control parameters of the gates. Computing E(θ) may involve computing the expectation values of all the Pauli strings in the Hamiltonian, [symbol] Ψ(θ)|P_{α}|Ψ(θ) [symbol] , from the provided measurement results.

According to processing operation 506, parameters of the parametrized quantum gates are updated using a classical optimization algorithm to minimize the variational energy. The classical optimization algorithm may be of various types. In some cases, the classical optimization algorithm is the Nelder-Mead algorithm. In some cases, the algorithm is the Adam algorithm, and gradients of the variational energy are approximated by using the shift rule, or using finite-difference gradients, or a combination of the two.

Still referring to FIG. 5 and according to processing operation 508, a stopping criterion is verified; if the stopping criterion is met, the resulting quantum state is provided according to processing operation 510; if the stopping criterion is not met processing operations 500, 502, 504 and 506 are repeated. In some cases, the stopping criterion is that processing operations 500, 502, 504 and 506 are repeated a given number of times. In some cases, the stopping criterion is that the parameters of the quantum gates converge.

Now referring back to FIG. 1, in some cases, each of the following may be performed together or separately, in whole or in part: preparing a quantum state, training a neural network representative of the quantum state, and performing a variational Monte Carlo procedure. In some cases, measurement results obtained from the prepared quantum state are used to train a neural network in a variational Monte Carlo procedure. In some cases, measurement results obtained from the prepared quantum state are used instead of operation 400 in FIG. 4. In some cases, the neural network is trained by alternating between at least one training iteration described in processing operations 300, 302, 304 and 306 in FIG. 3, and at least one training iteration described in processing operations 400, 402, 404 and 406 in FIG. 4. In some cases where preparing the quantum state comprises variational quantum computation, the neural network takes as an additional input the parameters of the variational quantum computation and is trained to be representative of a plurality of quantum states which are prepared with a plurality of values of the parameters of the variational quantum computation. In some cases, the quantum state resulting from performing processing operations in FIG. 3 or performing processing operations in FIG. 4 is used in processing operation 506 in FIG. 5 to update the parameters of the quantum gates.

Now referring to FIG. 7, there is shown a diagram of a system for improving an estimation of a property of a quantum state. The system comprises a digital computer 700 comprising at least one processing device 706, a display device 708, an interface 710, communication ports 714, and a memory 712 comprising a computer program executable by the processing device to obtain an indication of a property of a quantum state to be estimated, a set of measurement operators, at least one quantum device and at least one computational platform; to obtain a plurality of measurement results of said quantum state prepared experimentally; and to communicate with a quantum device 704 and a computational platform 702. In some cases, the digital computer 700 may be of various types, such as any digital computer disclosed herein.

The system further comprises at least one computational platform 702. The computational platform 702 is operatively connected to the digital computer 700. The computational platform 702 comprises at least one processing unit. In some cases, the at least one processing unit 714 may be of various types such as any processing unit disclosed herein. More precisely, the at least one processing unit may comprise at least one member of the group of hardware consisting of FPGA, ASIC, GPU, TSP, CPU, and TPU. The computational platform further comprises a readout control system 718.

The system further comprises at least one quantum device 704. The quantum device 704 comprises at least a quantum processor 722 and a read-out control system 720. The quantum device 704 may be of various types such as any quantum processor disclosed herein. More precisely, the at least one quantum device may be at least one member of the group consisting of a superconducting quantum computer, a trapped ion quantum computer, an optical lattice quantum computer, a spin-based quantum dot computer, a spatial based quantum dot computer, coupled quantum wires, a nuclear magnetic resonance quantum computer, a solid-state NMR Kane quantum computer, an electrons-on-helium quantum computer, a cavity quantum electrodynamics-based quantum computer, a molecular magnet-based quantum computer, a fullerene-based ESR quantum computer, a linear optical quantum computer, a diamond-based quantum computer, Bose-Einstein condensate-based quantum computer, a transistor-based quantum computer, a rare-earth-metal-ion-doped inorganic crystal-based quantum computer, a metal-like carbon nanospheres based quantum computer, a quantum annealer.

In some cases, each of the hardware may be used as part of the system, to execute the whole method, or any part of it, alone, or in combination with other hardware. In some cases, the hardware may be used for: experimentally prepare an approximation of the quantum state, performing measurement of the prepared quantum state, computing value of the neural network cost function, computing gradient of the cost function, estimating variational energy of the wavefunction, generation of random numbers, updating neural network parameters, updating parameters of parametrized quantum gates, performing quantum evolution, execution of functions of the interface, including a part or all of the above.

### Schwinger Model

The lattice Schwinger model describes the interactions between a scalar fermion field and an abelian quantized electromagnetic field in 1-dimension. Using a Kogut-Susskind encoding, open boundary conditions and a Jordan-Wigner transformation, the lattice Schwinger Hamiltonian can be written as

$$\hat{H} = w {\sum }_{j} ( {\hat{σ}}_{j}^{+} {\hat{σ}}_{j + 1}^{-} + h . c . ) + \frac{m}{2} {\sum }_{j} {( - 1 )}^{j} {\hat{σ}}_{j}^{z} + g {\sum }_{j} {\hat{L}}_{j}^{2} .$$

The first term describes the creation or annihilation of a fermionic pair with a spin flop term w. The second term is the mass term with the bare mass m. The last term is the electric field energy with coupling g. The behavior of the system may be studied as a function of the mass m while setting g=w =1. Gauss's law allows the electric field \hat{L}ⱼ to be eliminated and expressed as,

$${\hat{L}}_{j} = {ϵ}_{0} - \frac{1}{2} {Σ}_{l = 1}^{j} ( {\hat{σ}}_{l}^{z} + {( - 1 )}^{l} ) ,$$

where ϵ₀ is the background electric field, which is set to zero. The Hamiltonian reduces to an effective spin-1/2 model with long range interactions. It can be written as

$$\hat{H} = {\sum }_{j} ( {\hat{σ}}_{j}^{+} {\hat{σ}}_{j + 1}^{-} + h . c . ) + \frac{m}{2} {\sum }_{j} {( - 1 )}^{j} {\hat{σ}}_{j}^{z} + \frac{1}{4} {\sum }_{j} {( {\sum }_{l = 1}^{j} ( {\hat{σ}}_{l}^{z} + {( - 1 )}^{l} ) )}^{2} .$$

The energy, entanglement entropy and order parameter for the ground states are the properties of interest. The quantum phase transition may be detected by computing the order parameter O of the Hamiltonian. For the Schwinger model, the order parameter is

$$〈 𝔒 〉 = \frac{1}{2 N ( 1 - 2 N )} {\sum }_{i , j > i} 〈 ( 1 + {( - 1 )}^{i} {\hat{σ}}_{i}^{z} ) ( 1 + {( - 1 )}^{j} {\hat{σ}}_{j}^{z} ) 〉 .$$

Variational quantum simulations (VQS) of the lattice Schwinger model have been shown to converge to the ground state. (Kokail et al., “Self-verifying variational quantum simulation of lattice models,” Nature, Issue 569, no. 7756, (May, 2019) pp.355-360, which is incorporated herein by reference in its entirety). Variational quantum simulations are quantum-classical optimization methods used to find ground states of a given Hamiltonian such as a variational quantum procedure shown in FIG. 5. In this example, the samples will be obtained from an imperfect ground state prepared using VQS. Measurements from sampling a state prepared using a quantum device, in this case a VQS state are obtained. A trainable parameter, the phase \vec{ϕ} of the ground state |Ψ_{λ} [symbol] is trained using the error mitigation procedure disclosed herein. The information about the phase is obtained by taking measurements in the x and y bases in addition to the computational basis. Specifically, the measurements are taken to be [Z,Z, . . . ,Z], [Z, . . . Z, X, X, Z, Z], [Z, . . . Z,X,Y,Z, . . . Z], which is referred to as “xyz” measurements in FIG. 7. This provides information about (Xᵢ [symbol] and (Yᵢ [symbol] for each qubit.

Then a neural network quantum state (NNQS) is trained on that measurement dataset D, updating the neural network parameters \vec{λ}. After computing the observables for the NNQS trained using tomography, a post-process is performed on the NNQS using variational Monte Carlo.

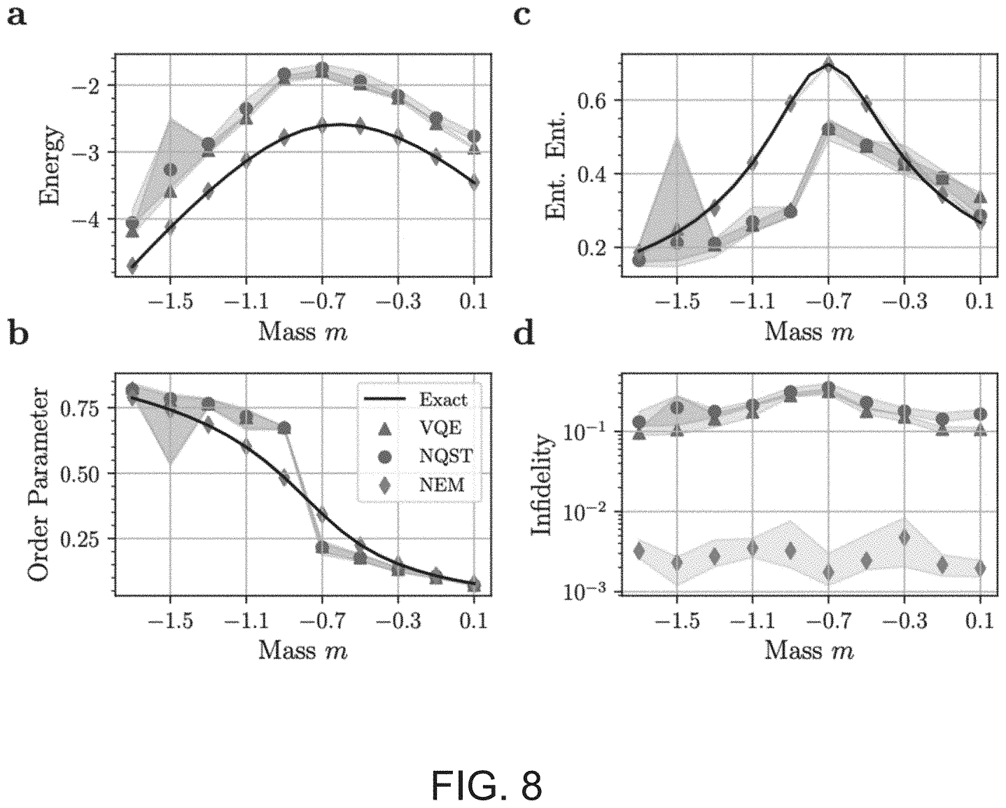

Now referring to FIG. 8 there are shown the results for error mitigation using variational Monte Carlo, which is also referred to as neural error mitigation (NEM), on the Lattice Schwinger model with N=8 sites over the mass values m from [−1.8,1.0]. Shown are the estimates for the ground state energy (a), order parameter (b), entanglement entropy (c) and infidelity to exact ground state (d). Each panel contains results for the VQS prepared quantum states (blue triangles), NNQS trained using neural quantum state tomography (NQST, green circles), the final neural error mitigated NNQS (NEM, red diamonds) and, where applicable, exact results (solid black lines). In all panels, median values over ten runs are shown with the shaded region encompassing three values on either side of the median.

As shown in FIG. 8, the simple VQS scheme may be configured to approximately represent the ground state of the lattice Schwinger model. While the qualitative behavior of the exact ground state energy as a function of the mass can be somewhat reproduced by VQS, the qualitative behaviors of other physical properties (order parameter, entanglement entropy and infidelity) may not be reproduced well, which can limit the utility of VQS alone for studying this model. During the first operation in the error mitigation protocol, tomography can accurately reconstruct the optimized VQS result with the chosen measurement bases (see, for example, NQST results). The purpose of this operation may be to extract information about the imperfect ground state approximation prepared using VQS from experimental measurements.

Analyzing the results for the error mitigation method disclosed herein, the properties of the final NEM result show a substantial improvement over VQS. In particular, post-processing the tomography NNQS using variational Monte Carlo can significantly improve the estimations of the ground state wave function as represented by the NNQS and the ground state observables. The NEM state reaches absolute energy errors of the order 10⁻² and infidelities approaching 10⁻³. Importantly, it is shown that using the error mitigation method disclosed herein can extend the VQS results to low errors and low infidelities.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for reducing an error in an estimation of a property of a quantum state, the method comprising:
(a) receiving a plurality of measurements of a quantum state from a quantum device;
(b) using a computational platform and said plurality of measurements to prepare a representation of said quantum state, wherein said representation comprises a neural network comprising one or more tunable parameters; and
(c) training said neural network by adjusting said one or more tunable parameters using said computational platform to variationally improve said quantum state, and wherein said training reduces an error in said estimation of said property of said quantum state.

2. The method of claim 1, wherein (c) comprises performing a variational Monte Carlo procedure.

3. The method of claim 2, wherein said variational Monte Carlo procedure comprises one or more neural networks that are representative of, respectively, an ansatz ground state wavefunction, a tensor network ansatz, a Jastrow wavefunction, or a Hartree-Fock wavefunction.

4. The method of claim 1, further comprising prior to (a) using an interface of a digital computer to receive an indication of a property of a quantum state to be estimated; and
subsequent to (c) providing said estimation of said property of said quantum state at said interface.

5. The method of claim 1, further comprising repeating (a)-(c) until a stopping criterion is met.

6. The method of claim 1, further comprising prior to (a) receiving an indication of a set of measurement operators; and wherein (a) further comprises, until a stopping criterion is met:
(i) using a quantum experiment to experimentally prepare an approximation of said quantum state;
(ii) selecting a measurement operator from said set of measurement operators; and
(iii) performing a measurement of said prepared approximation of said quantum state using said selected operator from said set of measurement operators.

7. The method of claim 1, wherein said neural network further comprises a cost function; further wherein (b) comprises:
(i) using said plurality of measurements to provide an input to said neural network;
(ii) computing a value of said neural network cost function;
(iii) computing a gradient of said cost function with respect to said one or more tunable parameter of said neural network;
(iv) using said computed gradient and said computed cost function to update said one or more tunable parameter of said neural network; and
(v) repeating (i)-(iv) any number of times.

8. The method of claim 3, wherein (c) further comprises:
(i) using said neural network to sample at least one configuration;
(ii) using said at least one sampled configuration to estimate a variational energy of said wavefunction represented by a mean of a local energy;
(iii) using said at least one sampled configuration to estimate a gradient of said variational energy with respect to said one or more tunable parameters of said neural network;
(iv) using said estimated variational energy and said estimated gradient of said variational energy to update said one or more tunable parameters of said neural network; and
(v) repeating (i)-(iv) until a stopping criterion is met.

9. The method of claim 6, wherein said quantum experiment comprises one or more of a quantum computation, a circuit model quantum computation, a quantum annealing measurement-based quantum computation, and an adiabatic quantum computing.

10. The method as of claim 1, wherein said quantum state comprises a ground state of a Hamiltonian.

11. The method of claim 9, wherein said quantum computation comprises solving an optimization problem; and further wherein said quantum state comprises a ground state of a Hamiltonian.

12. The method of claim 11, wherein said Hamiltonian is representative of a classical optimization problem.

13. The method of claim 11, wherein said ground state of said Hamiltonian is representative of an optimal solution of said optimization problem.

14. The method of claim 1, wherein (b) comprises performing a variational quantum computing procedure.

15. The method of claim 9, wherein said quantum computation comprises a quantum chemistry simulation; and wherein said quantum state is of a Hamiltonian representative of a quantum chemistry problem.

16. The method of claim 15, wherein said Hamiltonian comprises electronic structure Hamiltonian of one of a molecule and material.

17. The method of claim 1, wherein said property of said quantum state comprises an observable of said quantum state.

18. The method of claim 17, wherein said observable of said quantum state is an expected energy of said quantum state.

19. The method of claim 1, wherein said neural network comprises at least one of an autoregressive model, a recurrent neural network, a transformer, an autoregressive generative model, an attention-based architecture, a dense deep neural network, a convolutional neural network, a variational autoencoder, a generative adversarial network, a restricted Boltzmann machine, a general Boltzmann machine, an energy-based model, an invertible neural network, and a flow-based generative model.

20. The method of claim 1, wherein said quantum state is of a parametrized Hamiltonian, further wherein a parametrization of said parameterized Hamiltonian is continuous.

21. The method of claim 20, wherein said neural network is configured to further receive a parameter value of said parameterization as an input.

22. The method of claim 20, further comprising providing an estimation of a property of said quantum state using a neural network inference for estimation of a property of a quantum state of said parametrized Hamiltonian with a second parameter value, wherein the second parameter is not being used in training.

23. A system for improving an estimation of a property of a quantum state, the system comprising:
(a) a digital computer comprising an interface, a memory comprising instructions, wherein said digital computer is configured to execute said instructions to at least: receive a plurality of measurements of a quantum state; use a computational platform and said plurality of measurements to prepare a representation of said quantum state, wherein said representation comprises a neural network comprising one or more tunable parameters; and train said neural network by adjusting said one or more tunable parameters using said computational platform to variationally improve said quantum state;
(b) at least one quantum device operatively connected to said digital computer, wherein said at least one quantum device comprises at least a quantum processor and a readout control system, wherein said at least one quantum device is configured to conduct a quantum experiment to obtain said plurality of measurements of said quantum state using said readout control system; and
(c) said at least one computational platform operatively connected to said digital computer, wherein said at least one computational platform comprises at least one processor and a readout control system, wherein said at least one computational platform is configured to (i) receive from said digital computer a configuration of a neural network comprising at least one tunable parameter, and said plurality of measurements; (ii) to train said neural network representative of said quantum state by adjusting said at least one tunable parameter of said neural network to variationally improve said quantum state.

24. The system of claim 23, wherein said computational platform comprises at least one member of the group consisting of a field-programmable gate array (FPGA), an application-specific integrated circuit (ASIC), a central processing unit (CPU), a graphics processing unit (GPU), a tensor processing unit (TPU), and a tensor streaming processor (TSP).

25. The system of claim 23, wherein said quantum device comprises at least one of a quantum annealer, a trapped ion quantum computer, an optical quantum computer, a photonics-based quantum computer, a spin-based quantum dot computer, and a superconductor-based quantum computer.
